(19) United States
(12) Patent Application Publication
(10) Pub. No.: US 2017/0217324 A1
(43) Pub. Date: Aug. 3, 2017

(54) VEHICLE CHARGING STATION WITH AN ARTICULATED ARM

(71) Applicant: SIEMENS AKTIENGESELLSCHAFT, MUENCHEN (DE)

(72) Inventors: FLORIAN BUEHS, BERLIN (DE); PETER ENENKEL, KONSTANZ (DE); JUERGEN FRANCKE, BERLIN (DE); ANDREAS LASKE, BERLIN (DE); ANDRE ROMPE, BERLIN KAULSDORF (DE); FRANK VOSS, BERLIN (DE)

(21) Appl. No.: 15/328,093

(22) PCT Filed: Jun. 23, 2015
(86) PCT No.: PCT/EP2015/064079

§ 371 Date: Jan. 23, 2017

(30) Foreign Application Priority Data
Jul. 23, 2014 (AT) A 50508/2014

(51) Int. Cl. B60L 11/18; H01M 10/44

(52) U.S. Cl. CPC B60L 11/1818; H01M 10/44; B60L 11/1825; B60L 11/1838; H01M 2220/20; B60L 2200/18; B60L 2230/10

(57) ABSTRACT

A vehicle charging station charges an energy accumulator in a battery-driven vehicle, namely an electric bus or hybrid vehicle, the vehicle being parked in a pre-defined parking position during the charging process. The charging station contains a base which is arranged in the vicinity of the pre-defined parking position and an articulated arm. One end of which is mounted in a revolute joint on the base and is rotary driven by a rotary drive and the other end is connected to a supply-contact device by a second revolute joint, such that the supply-contact device can be moved, by a pivoting movement of the articulated arm, between an idle position, in which the supply-contact device is positioned above the vehicle roof, and a working position, in which, for charging purposes, electrical contact is made between the supply-contact device and a receiving-contact device arranged in a static manner on the vehicle roof.

### TECHNICAL AREA

The invention relates generally to the technical area of electric vehicles, in particular a charging station and a method for charging an energy accumulator in an electric vehicle.

### PRIOR ART

Within the local public transport field, battery-driven transport systems have long been known, for example from DE 24 05 198. Recently, fully electric buses are also being employed, whose entire energy requirements are covered via the on-board battery system. In the urban area of Vienna, fully electric buses of this kind are today already in use, which derive their drive power totally from multiple on-board lithium-ferrite batteries with a total capacity of around 100 kWh. The batteries are here in part accommodated on the roof or at the rear of the vehicle. These batteries are recharged within around 15 minutes during the operating time in each case at a terminus of the bus line and overnight, if the fully electric bus is not in operation. For charging purposes a pantograph provided on the vehicle roof of the electric bus is extended at the press of a button and brought into contact with an overhead line above the electric bus. Before the start of the journey, contact with the overhead line is once again broken by means of a manual switching action.

It is here disadvantageous that the pantograph including the elevation and lowering apparatus is carried on the vehicle roof. This calls for additional drive energy and reduces the payload of the fully electric bus. In addition the elevation and lowering apparatus comprises multiple moving parts. Along with the drive technology on the roof they are exposed to unfavorable climatic conditions and are susceptible to disruption. In addition the structure of the extendable pantograph on the vehicle roof occupies structural space which limits the drive-through height of the electric bus. Manual switching actions are required for the charging process. A charging process which proceeds automatically would however be desirable.

### REPRESENTATION OF THE INVENTION

It is an object of the present invention to avoid the aforementioned disadvantages and to create an approach with which if possible no on-board contact device with moving parts is required for charging of the energy accumulator of a battery-driven vehicle and wherein the charging process is largely capable of automation.

The object is achieved by means of a charging station for an electric vehicle according to the features of claim 1, by means of a method according to the features of claim 7, and by means of a vehicle according to the features of claim 11.

Advantageous embodiments, aspects and particular details of the invention derive from the respective dependent claims, the description and the appended drawing.

The invention is based on the idea that during the charging of the energy accumulator of a stationary electric vehicle located in a pre-defined parking position, rather than an on-board contact device docking with an overhead line network, the station-based contact device is movable.

The inventive charging station comprises
a) a base, which is arranged in the vicinity of the pre-defined parking position;
b) an articulated arm, one end of which is mounted in a revolute joint on the base and is rotary driven about an axis by means of a rotary drive and the other end of which is connected to a station-based contact device by means of a second revolute joint, so that the station-based contact device can be moved by means of a pivoting movement between an idle position (FIG. 3), in which the station-based contact device is located above the vehicle roof, and a working position (FIG. 1), in which electrical contact is made between the station-based contact device and a contact device mounted in a static manner on the vehicle roof.

A significant advantage stems from the fact that an on-board pantograph with moving parts is no longer required. The weight of each vehicle is correspondingly lower. The on-board contact apparatus can be simply embodied, for example by means of strip-like contact elements, which are essentially arranged on the vehicle roof flush with the vehicle profile. The contact device on the vehicle roof is thus robust and less susceptible to disruption as regards climatic influences. The procedure for charging can be automated.

In one preferred embodiment, the contact device arranged on the vehicle roof is formed by an arrangement of at least two longitudinal contact strips. Because of their size, these contact strips are dimensioned such that within a prescribed parking position tolerance an electrical connection can be reliably created between the contacts conducting the charging voltage which are guided to the vehicle by means of the pivoting movement of the pivoting and the on-board contacts. The contact strips can here be arranged either in the direction of the longitudinal extension of the vehicle or transversely to this on the vehicle roof. As a result the parking position tolerance limit in the first case in the direction of travel, and is increased in the second case transversely to the direction of travel.

A very particularly preferred embodiment can provide for the station-based contact device to have four contact strips arranged in the form of a cross, which interact with corresponding contact strips, which are arranged on the vehicle roof in the form of a rectangle. It is here favorable if the contact strips of the cross are of the same length, and the contact strips of the rectangle form lateral sections of a square. A favorable tolerance range for the pre-defined parking position of the vehicle thereby results, both in the direction of travel and transversely to the direction of travel. It is sufficient if the vehicle-parking position lies within these boundaries.

In another preferred embodiment it can also conversely be provided that the station-based contact device, that is that contact device which is lowered onto the vehicle roof by the pivoting movement, comprises four contact strips arranged in the form of a square or rectangle, and contact sections in the form of a cross are arranged on the vehicle roof.

As regards the establishing of a good contact it can be favorable if the rotary drive is an electrical positioning drive and the second revolute joint is operatively coupled with this rotary drive in such a way that in the working position (charging position) contact elements of the supply-contact device are aligned essentially parallel to the plane of the vehicle roof and lie flat against corresponding contact elements of the receiving-contact device, held by spring force.

The problem set out in the preamble is also solved by a method for charging the energy accumulator in a battery-driven vehicle, wherein the vehicle is brought into a predefined parking position and wherein a charging station having the following is used:
i. a base, which is arranged in the vicinity of the pre-defined parking position;
ii. an articulated arm, one end of which is mounted in a revolute joint on the base and is rotary driven about an axis by a rotary drive and the other end of which is connected is connected to a contact device by means of a second revolute joint;

Wherein the method has the following method step:
iii. the contact device is pivoted by means of a pivoting movement between an idle position (FIG. 3), in which the contact device is located above the vehicle roof, and a working position (FIG. 1), in which an electrical connection is established between the contact device and a contact device arranged on the vehicle roof.

It is here favorable if the pivoting movement between the idle position and the working position takes place in a pivoting plane which is arranged essentially at right angles to the direction of the longitudinal extension of the vehicle parking in the parking position. It is thereby possible that the articulated arm, both on a vehicle parked on one side of the base, and also alternately on a vehicle parked on the opposite side of the base, pivots and makes the contact for charging.

If the rotary drive is controlled by an electrical control device, to which the signal from a parking position detection device is fed, it is possible for the charging process to proceed fully automatically.

The invention also relates to a battery-driven vehicle, in which a receiving-contact device is attached fixedly to the vehicle roof or a side wall, which has longitudinal contact strips, which are arranged either in the form of a cross or in the form of a square/rectangle. As already mentioned, the position of the vehicle in the parking position can then vary within boundaries prescribed by the cruciform or square shape and does not need to be so precise.

It is here advantageous if the individual contact strips or contact strips are embodied from a material of good electrical conductivity, e.g. copper, and are embedded at least in part in a contact plate made of an electrical insulator.

Advantageously, the contact plate is a truncated pyramid, which is fixedly mounted with its base surface on the vehicle roof. The contact strips are arranged on the top surface of the truncated pyramid facing away from the base surface and can protrude from this top surface. Thanks to the sloping lateral surfaces of the truncated pyramid, rainwater which occurs is effectively deflected.

### BRIEF DESCRIPTION OF THE DRAWING

For further explanation of the invention reference will be made in the next part of the description to drawings from which further advantageous embodiments, details and developments of the invention are to be derived on the basis of a non-limiting exemplary embodiment.

Wherein:

FIG. 1 shows a vehicle charging station with an articulated arm according to the invention in a schematic side view;

FIG. 2 shows a top view according to FIG. 1;

FIG. 3 shows idle positions of the articulated arm;

FIG. 4 shows contact strips arranged on a vehicle roof;

FIG. 5 shows a preferred variant of the invention with a contact device comprising four contact strips.

### EMBODIMENT OF THE INVENTION

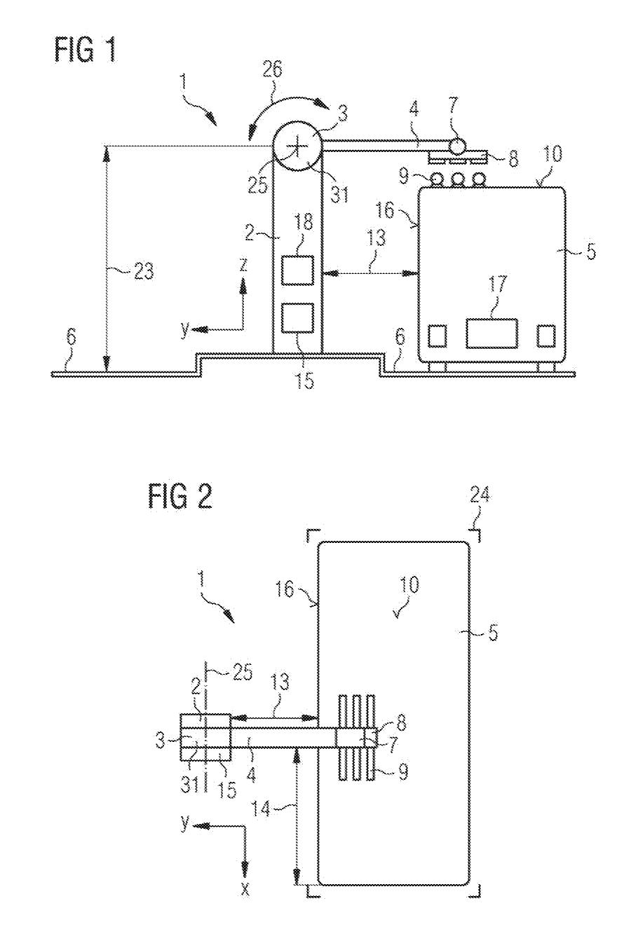

FIG. 1 shows a frontal view of a vehicle charging station 1. The vehicle charging station 1 essentially comprises a fixed base or framework 2 and an articulated arm 4 mounted therein. It is assumed that a parking vehicle 5, is located in a pre-defined parking position 24 (FIG. 2) on a roadway 6. The vehicle 5 is battery-driven and not rail-mounted, for example a fully electric bus as mentioned in the preamble. The column-shaped base 2 is arranged adjacent to the vehicle 5, at a distance 13 from the edge of the roadway. A revolute joint 3 is arranged at an upper end of the column-shaped base 2, at a height 23 from the roadway 6. One end of the articulated arm 4 is mounted in this revolute joint 3. The articulated arm 4 can be pivoted about an axis 25 (FIG. 2) by means of a rotary drive 31. In FIG. 1 this pivoting movement is indicated by the double arrow 26. With its other end the articulated arm 4 functions as the carrier of a station-based contact device, in that it bears a supply-contact device 8 with its end facing away from the base 2. This supply-contact device 8 is electrically connected with an energy supply network (drive voltage network) which is not represented in greater detail in the drawings. The electrical energy required for the charging process of the on-board energy accumulator 17 is taken from this energy supply network. The mechanical connection between the articulated arm 4 and the contact device 8 creates a further revolute joint 7.

As will be explained in greater detail below, the revolute joint 7 is operatively connected to the rotary drive 31.

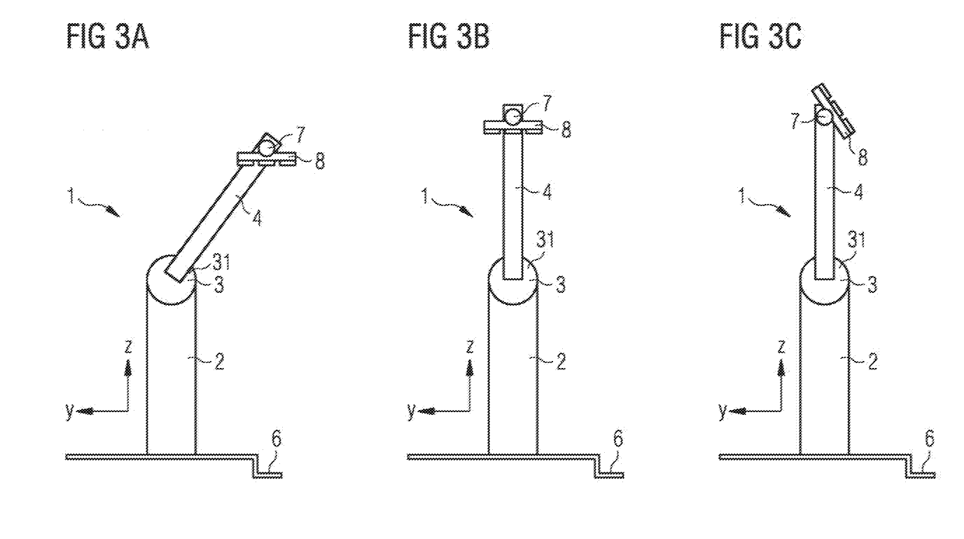

The FIG. 1 shows the articulated or pivoting arm 4 in a so-called working position. The working position corresponds to a battery-charging position, that is to say the energy accumulator 17 of the vehicle 5 is charged. To this end the articulated arm 4 was previously lowered from an idle position, in which the supply-contact device 8 was located above the vehicle roof 10 (see FIG. 3a, 3b, 3c), into the working position by means of a pivoting movement. In the working position electrical contact is made between the corresponding contact elements of the supply-contact device 8 and receiving-contact device 9 located on the vehicle roof 10. In the representation of FIG. 1 this pivoting movement takes place in a clockwise direction. As however already indicated by the double arrow 26 in FIG. 1, it is of course also possible to charge, alternately, not only this vehicle 5 represented in FIG. 1, but also a vehicle 5 located on the other side of the base 1, in that the articulated arm 4 in FIG. 1 is pivoted not clockwise but counterclockwise.

For charging of the energy accumulator 17 of the battery-driven vehicle 5 the vehicle 5 is thus initially moved into a prescribed parking position 24 and parked there. The supply-contact device 8 of the articulated arm 4 is then lowered onto the vehicle roof 10 by means of a pivoting movement, so that an electrical connection can be made between contacts of the supply-contact device 8 and corresponding contacts of the receiving-contact device 9. As stated, this lowering takes place via a rotary movement of the articulated arm 4, which is mounted in the revolute joint 3 of the base 2 and is driven by a rotary drive 31 which is not represented in greater detail.

The rotary drive 31 is a position-regulated electrical drive, which is coupled with the revolute joint 7 in an operative connection. This coupling can be embodied mechanically (connecting rods), or by the joint 7 likewise being driven by a drive which is not represented in greater detail. In this way a defined position of the contact device 8 relative to the roadway 6 or vehicle roof 10 can be set, for example parallel to the road surface 6. It is thereby possible that within certain limits, height differences between on-board contact device 9 and roadway 6 can be compensated for. These height differences can for example stem from different loading, unevenly distributed loads, changes in tire pressure or the type of vehicle. The rotary drive 31 need not be electric, but can also be a controlled pneumatic or hydraulic drive. The individual contact elements of the supply-contact device 8 can be embodied in a different manner, for example metal brushes, which are pre-tensioned with a spring.

The drawing in FIG. 1 shows the arrangement of the joint 3 or rotary drive 31 at a height 23 from the roadway 6. In order to enable the charging of vehicles 5 with a different height (z-direction) between vehicle roof 10 and roadway 6, a linear drive device is provided in the base 2, with which the height 23 can be set within certain boundaries.

The drawing in FIG. 2 shows the working position as a top view. On the vehicle roof 10 is located an on-board receiving-contact device 9, which comprises three contact strips or contact strips aligned in the direction of the longitudinal extension of the vehicle 5. The axis of rotation 25 of the revolute joint 3 runs approximately parallel to the roadway 6 or to the longitudinal extension of the parking vehicle 5 (x-direction).

The receiving-contact device 9 is arranged in a static manner on the vehicle roof 10, and has no moving parts. It comprises contact strips or contact strips, which are embedded in an insulator-contact plate in a plane parallel to the plane of the vehicle roof 10.

The electrical energy for charging the vehicle battery 17 is here taken from an energy supply network, which is not further represented here. The charging process is here controlled by a control device 18 arranged in the base 2. The control device 18 also controlled the rotary drive 31, so that the establishment of the electrical contact and the charging process are automatically initiated, as soon as the vehicle 5 is located within prescribed boundaries of a pre-defined parking position 24 and is released for charging.

A position detection device 15 here monitors the correct parking position 24 of the vehicle 5. This position detection device 15 can for example contain a device for measuring the distance 13 (y-direction) between the column-shaped base 2 and the side wall 16 of the vehicle 5, and a recording of the position in the direction of travel (x-direction). If the vehicle 5 is located outside a pre-defined parking position 24, an automatic charging process will then not be performed and this incorrect position of the vehicle 5 is indicated by means of an acoustic and/or optical signal.

As shown in FIG. 2, the vehicle parking position 24 is delineated by means of markings. The pivoting movement of the articulated arm 4 takes place about the axis of rotation 25, which runs approximately parallel to the direction of travel (x-direction) of the vehicle 5. As already stated, the position of the vehicle 5 is recorded or monitored before the charging process, that is to say the lateral distance 13 between base 2 and side wall 16 of the vehicle 5 (distance in the y-direction) and the distance 14 in the direction of travel (x-direction) are measured. Only when the vehicle 5 is located in a prescribed tolerance field of the parking position 24 is an automatic charging process initiated.

The idle position of the articulated arm 4 can differ depending on the characteristics of the operating site. FIG. 3a shows an idle position in which the height is limited. In FIG. 3b and FIG. 3c structural height is not restricted at the installation location of the base 2, the articulated arm 4 is extended. In the idle position of FIG. 3b the contact strips of the supply-contact device 8 point downwards (z-direction). They are thereby largely protected against climatic influences. The idle position of the articulated arm 4 shown in FIG. 3c shows an idle position, in which the clearance of high-bodied vehicles passing on the roadway 6 is not impeded.

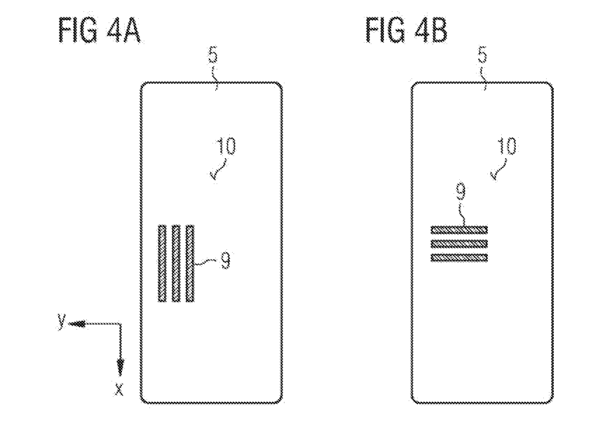

The FIG. 4 shows, in a top view of the vehicle roof 10, two possible arrangements of the on-board receiving-contact device 9. In FIG. 4a the contact device 9 comprises three contact strips arranged parallel to each other, which are aligned with the longitudinal extension of the vehicle (FIG. 4a) and transversely to the longitudinal extension of the vehicle (FIG. 4b). Upon docking with the station-based contact device 8, in the first case the tolerance is less severely limited in the direction of travel (x-direction), and in the second case transversely to the direction of travel (that is to say in the y-direction).

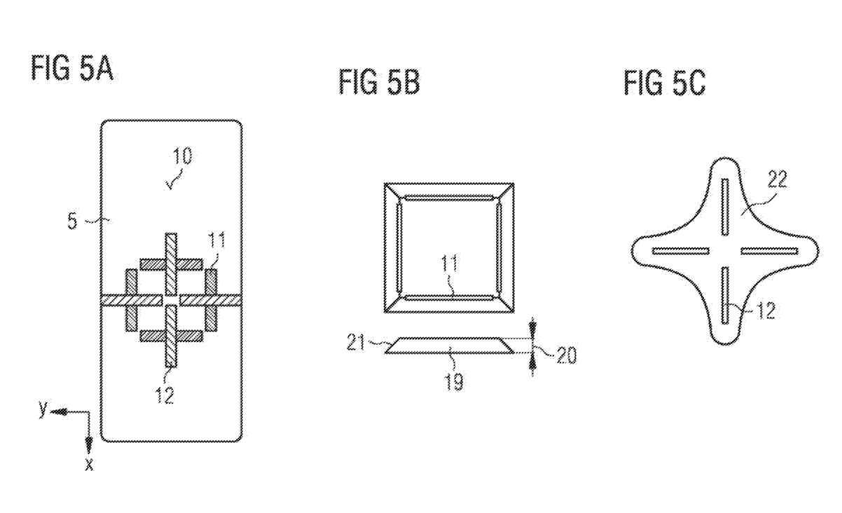

A particularly advantageous embodiment of the invention is shown in schematic form in FIG. 5a. It enables a greater tolerance both in the x- and the y-direction. The station-based supply-contact device 8 here comprises either four unconnected contact strips, which are arranged either in the form of a square or rectangle 11 or in the form of a cross 12. If the on-board contact device 9 has contact strips in the form of a square, the contact strips of the station-based contact device 8 are arranged in the form of a cross, and vice versa. Docking of the contact devices 8, 9 is thereby considerably simplified. The requirements in terms of the precision of the vehicle 5 in the parking position 24 are thereby less stringent (depending on the embodiment of the rectangular shape and the corresponding cruciform shape). Different and comparatively greater variances are permissible both in the direction of travel and also transversely to the direction of travel. The sensor system for recording the parking position of the vehicle can thereby be more simply structured.

The individual contact strips or contact strips are made of copper and in each case embedded in contact plates 19, 22 made from an electrical insulator.

FIG. 5b shows a possible embodiment in which the contact strips 4 arranged on the side lengths of a square are embedded in a contact plate 19 embodied as a truncated pyramid. The truncated pyramid has a height 20. The contact strips 11 are arranged on the surface of the truncated pyramid facing away from the base surface and protrude from this surface. If this contact plate 19 is arranged with the base surface lying on a vehicle roof 10, any rainwater occurring is effectively directed away from the contacts 11.

In FIG. 5c the counterpart belonging to FIG. 5b is represented with a cruciform contact arrangement 12, which likewise is embedded in a contact plate 22 made from an insulator. The station-based contact device 8 can basically be embodied either according to FIG. 5b or according to FIG. 5c. This depends solely on the corresponding counterpart (either rectangle/square with cross, or cross with rectangle/square).

The arrangement of the on-board contact device 9 can be arranged on one half of the vehicle roof 10 or on both. In the latter case a charging process for the vehicle 5 is possible in both directions of entry into parking position 24.

Although the invention has been illustrated and described in greater detail by means of the preferred exemplary embodiment, the invention is not limited by the example disclosed, and other variations can be derived by the person skilled in the art, without departing from the protective scope of the invention.

It is for example conceivable that the articulated arm is embodied from individual rotary-driven partial articulated arms, wherein each of these arms is embodied with individual contacts, for example one arm per pole. The partial arms can be mounted individually or together in the joint 3.

In the drawings the contact strips are represented as rectangles; other shapes are of course conceivable.

The arrangement of the contact strips in a rectangle or in a discontinuous cross is of course not limited solely to the forms represented and described in the drawing, but can also comprise other forms with in each case more than four station-based or on-board contact strips.

### SUMMARY OF REFERENCE CHARACTERS USED

1 Vehicle charging station
2 Base, fixed framework
3 Revolute joint
4 Articulated arm
5 Vehicle
6 Roadway
7 Second revolute joint,
8 Supply-contact device
9 Receiving-contact device
10 Vehicle roof
11 Contact strips, arranged in a rectangle
12 Contact strips, arranged in a cross
13 Distance between 2 and 5
14 Distance in vehicle direction
15 Parking position detection device
16 Side wall
17 Energy accumulator, on-board
18 Control device
19 Contact plate, on-board
20 Plate thickness
21 Slope
22 Contact plate
23 Distance between 3 and 6
24 Parking position
25 Axis of rotation
26 Arrow
31 Rotary drive

1-13. (canceled)

14. A vehicle charging station for charging an energy accumulator in a battery-driven vehicle, wherein the battery-driven vehicle parks during a charging process in a pre-defined parking position, the vehicle charging station comprising:
a base disposed in a vicinity of the pre-defined parking position;
a first revolute joint disposed on said base;
a second revolute joint;
a rotary drive;
a supply-contact device; and
an articulated arm, a first end of said articulated arm is mounted in said first revolute joint on said base and is rotary driven by said rotary drive, and a second end of said articulated arm is connected to said supply-contact device by said second revolute joint, so that said supply-contact device can be moved, by means of a pivoting movement of said articulated arm between an idle position, in which said supply-contact device is located above a vehicle roof, and a working position, in which for charging purposes electrical contact is made between said supply-contact device and a receiving-contact device disposed in a static manner on the vehicle roof.

15. The vehicle charging station according to claim 14, wherein said supply-contact device is set up to make electrical contact with contact strips of the receiving-contact device, which are disposed in a plane of the vehicle roof or in plane parallel hereto.

16. The vehicle charging station according to claim 15, wherein said supply-contact device is set up to make electrical contact with at least two longitudinal contact strips of the receiving-contact device, which are disposed in their longitudinal extension either in a direction of or transversely to a direction of a longitudinal extension of the battery-driven vehicle.

17. The vehicle charging station according to claim 15, wherein said supply-contact device has four contact strips, which are disposed in a form of a cross, in order to make electrical contact with corresponding contact strips of the receiving-contact device, which are disposed in a form of a square on the vehicle roof.

18. The vehicle charging station according to claim 15, wherein:
said supply-contact device has contact elements; and
said rotary drive is an electrical positioning drive and said second revolute joint is operatively coupled with said rotary drive such that in the working position, said contact elements of said supply-contact device are aligned parallel to a plane of the vehicle roof and lie flat against corresponding contact elements of the receiving-contact device, held by a spring force.

19. The vehicle charging station according to claim 15, wherein said rotary drive is disposed on said base at a height, wherein the height can set by means of a drive.

20. A method for charging an energy accumulator in a battery-driven vehicle, which comprises the steps of:
bringing the battery-driven vehicle into a predefined parking position, with a charging station for charging purposes;
disposing a base in a vicinity of the pre-defined parking position;
rotary driving an articulated arm, a first end of the articulated arm being mounted in a first revolute joint attached to the base and is rotary driven about an axis by a rotary drive, and a second end of the articulated arm being connected to a supply-contact device by a second revolute joint; and
pivoting the supply-contact device by means of the rotary drive from an idle position for charging of the energy accumulator, in which the supply-contact device is disposed in a position above a vehicle roof, into a working position, in which an electrical connection is made between corresponding contacts of the supply-contact device and a receiving-contact device disposed on the vehicle roof.

21. The method according to claim 20, wherein a pivoting movement between the idle position and the working position takes place in a pivoting plane which is disposed at right angles to a direction of a longitudinal extension of the battery-driven vehicle parked in the predefined parking position.

22. The method according to claim 21, which further comprises controlling the rotary drive with a control device.

23. The method according to claim 22, which further comprises feeding a vehicle position signal from a parking position detection device to the control device, by means of which the pivoting movement and the charging process are automatically initiated.

24. A battery-driven, not rail-mounted vehicle, comprising:
a vehicle roof; and
a receiving-contact device fixedly attached to said vehicle roof and having longitudinal contact strips, which are disposed either in a form of a cross, a square or a rectangle.

25. The vehicle according to claim 24, further comprising a contact plate formed from an electrical insulator, said longitudinal contact strips are embedded at least in part in said contact plate.

26. The vehicle according to claim 25, wherein said contact plate has a form of a truncated pyramid and said longitudinal contact strips are disposed in an area of edges of a top surface of said truncated pyramid.
